(19) United States
(12) Patent Application Publication
(10) Pub. No.: US 2005/0213497 A1
(43) Pub. Date: Sep. 29, 2005

(54) Method for reusing OVSF codes of allocated physical channels for transmitting data via enhanced up-link in CDMA

(75) Inventors: Joon-Young Cho, Suwon-si (KR); Ju-Ho Lee, Suwon-si (KR); Youn-Hyoung Heo, Suwon-si (KR); Yong-Jun Kwak, Yongin-si (KR); Young-Bum Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-shi (KR)

(21) Appl. No.: 11/057,344

(22) Filed: Feb. 14, 2005

(30) Foreign Application Priority Data
Feb. 14, 2004 (KR) 9821/2004
Feb. 20, 2004 (KR) 11565/2004
May 7, 2004 (KR) 32410/2004
Jun. 17, 2004 (KR) 45165/2004
Jul. 19, 2004 (KR) 56130/2004
Sep. 15, 2004 (KR) 73743/2004

(51) Int. Cl. H04J 11/00

(52) U.S. Cl. 370/208

(57) ABSTRACT

The present invention supposes a situation in which an Enhanced Uplink Dedicated transport Channel (EUDCH) is used in a mobile communication system. The present invention proposes a method for increasing the maximum possible number of code channels for E-DPDCH by dynamically allocating OVSF codes allocated to DPDCH and HS-DPCCH supporting a high-speed downlink packet service, to a E-DPDCH every TTI. Therefore, a Node B can normally demodulate E-DPDCH/DPDCH/HS-DPCCH data, increasing a EUDCH data rate.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating user equipments (UEs) performing uplink transmission and a Node B;

FIG. 2 is a diagram illustrating information exchanged between a UE and a Node B to perform uplink transmission;

FIG. 3 is a diagram illustrating a tree structure for general OVSF codes;

FIG. 4 is a diagram illustrating a UE's transmission operation of reusing OVSF codes of DPDCHs for E-DPDCHs according to a first embodiment of the present invention;

FIG. 5 is a diagram illustrating a Node B's reception operation corresponding to FIG. 4 according to the first embodiment of the present invention;

FIG. 6 is a diagram illustrating a UE's transmission operation of reusing OVSF codes of DPDCHs and an HS-DPCCH for E-DPDCHs according to the first embodiment of the present invention;

FIG. 7 is a diagram illustrating a Node B's reception operation corresponding to FIG. 6 according to the first embodiment of the present invention;

FIG. 8 is a diagram illustrating a UE's transmission operation of dynamically allocating OVSF codes to E-DPDCHs according to a second embodiment of the present invention;

FIG. 9 is a diagram illustrating a Node B's reception operation according to the second embodiment of the present invention; and

FIG. 10 is a diagram illustrating a structure and timing of uplink physical channels according to an embodiment of the present invention.

### DETAILED DESCRIPTION OF THE PREFERRED EMBODIMENT(S)

### OBJECT OF THE INVENTION

### RELATED FIELD AND PRIOR ART OF THE INVENTION

The present invention relates generally to a mobile communication system, and in particular, to a method for allocating optimal Orthogonal Variable Spreading Factor (OVSF) codes and in-phase/quadrature-phase (I/Q) channels for uplink physical channels for Enhanced Uplink Dedicated transport Channel (EUDCH) service.

Currently, a mobile communication system uses in its uplink a Dedicated Physical Data Channel (DPDCH) and a Dedicated Physical Control Channel (DPCCH) as typical dedicated channels to transmit user data. The DPDCH is a data transport channel over which user data such as voice and image is transmitted, and the DPCCH is a control information transport channel on which DPDCH frame format information and pilot information for DPDCH demodulation and power control are carried.

Recently, technology using a EUDCH which is an enhanced uplink data-only transport channel has been proposed to improve a rate and efficiency of packet data transmission in an uplink.

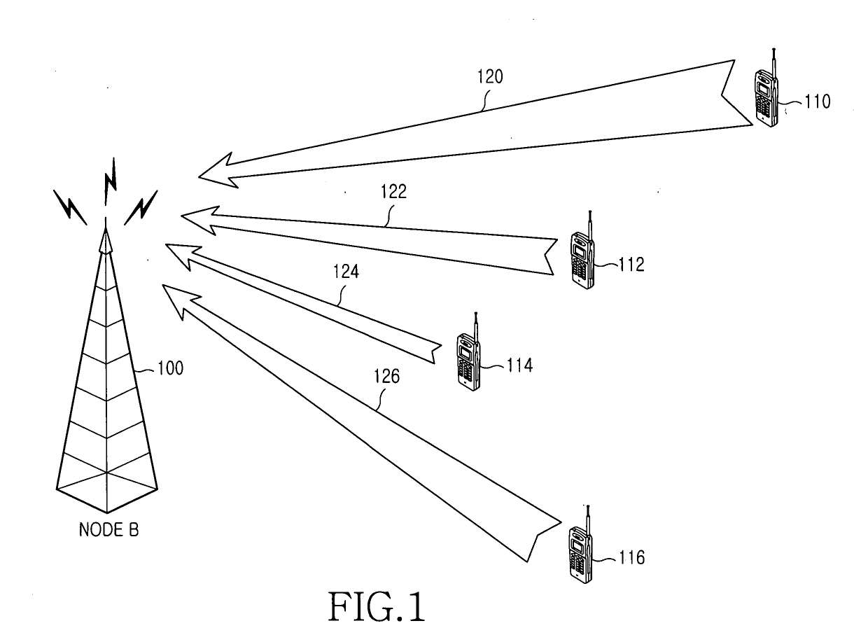

FIG. 1 is a diagram illustrating information exchanged between user equipments and a Node B to perform uplink transmission.

Referring to FIG. 1, UEs 110, 112, 114 and 116 transmit packet data with different transmission power according to their distances from a Node B 100. The UE 110 which is located in the longest distance from the Node B 100 transmits packet data with the highest transmission power 120 for the uplink channel, while the UE 114 which is located in the shortest distance from the Node B transmits the packet data with the lowest transmission power 124 for the uplink channel. In order to improve performance of the mobile communication system, the Node B 100 can perform scheduling in such a manner that a level of the transmission power for the uplink channel should be in reverse proportion to the data rate. That is, the Node B allocates the lowest data rate to a UE having the highest transmission power for the uplink channel, and allocates the highest data rate to a UE having the lowest transmission power for the uplink channel.

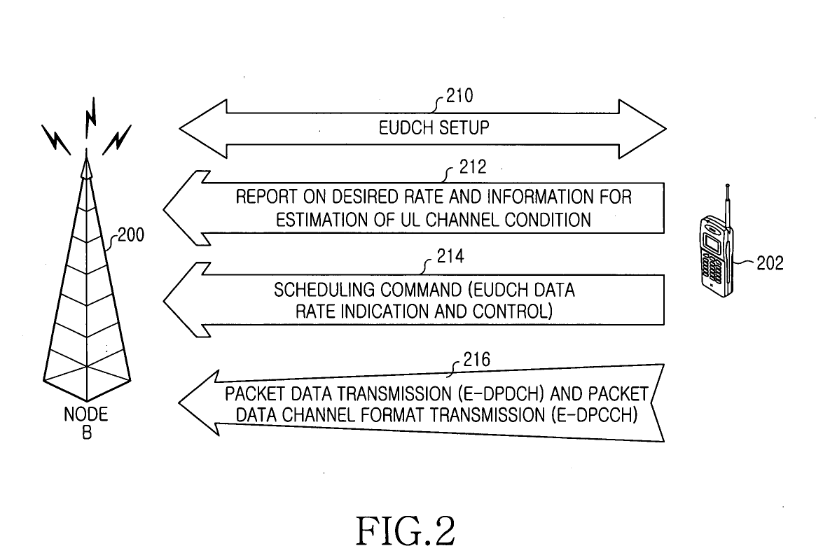

FIG. 2 is a diagram illustrating information exchanged between a UE and a Node B to perform uplink transmission. That is, FIG. 2 illustrates a basic procedure required between a Node B 200 and a UE 202 for packet data transmission through a EUDCH.

Referring to FIG. 2, in step 210, a EUDCH is set up between the Node B 200 and the UE 202. Step 210 includes a process of transmitting/receiving messages through a dedicated transport channel. After step 210, the UE 202 transmits in step 212 information on a desired data rate and information indicating an uplink channel condition to the Node B 200. The information indicating an uplink channel condition includes transmission power of an uplink channel transmitted by the UE 202 and a transmission power margin of the UE 203.

The Node B 200 receiving the uplink channel transmission power can estimate a downlink channel condition by comparing the uplink channel transmission power with reception power. That is, the Node B 200 considers that an uplink channel condition is good if a difference between the uplink channel transmission power and the uplink channel reception power is small, and considers that the uplink channel condition is bad if the difference between the transmission power and the reception power is great. When the UE transmits transmission power margin to estimate an uplink channel condition, the Node B 200 can estimate the uplink transmission power by subtracting the transmission power margin from the known possible maximum transmission power for the UE. The Node B 200 determines the possible maximum data rate for an uplink packet channel of the UE 202 using the estimated channel condition of the UE 202 and information on a data rate required by the UE 202.

The determined possible maximum data rate is notified to the UE 202 in step 214. The UE 202 determines a data rate for transmission packet data within a range of the notified possible maximum data rate, and transmits in step 216 the packet data to the Node B 200 at the determined data rate.

Herein, uplink physical channels supporting the EUDCH service include a Dedicated Physical Data Channel (DPDCH), a Dedicated Physical Control Channel (DPCCH), a High Speed Dedicated Physical Control Channel (HS-DPCCH) for HSDPA service, an Enhanced Dedicated Physical Data Channel (E-DPDCH) for the EUDCH service, and an Enhanced Dedicated Physical Control Channel (E-DPCCH) for the EUDCH service.

That is, in step 216, the UE 202 transmits an E-DPCCH which is a control channel to provide frame format and channel coding information of the E-DPDCH channel, and transmits packet data through the E-DPDCH. Herein, the E-DPCCH can also be used for transmission of an uplink data rate required by the UE 202 and transmission power margin, and transmission of pilot information required by the Node B 200 for demodulation of the E-DPDCH.

If the UE 202 additionally transmits separate physical channels in addition to the existing physical channels in order to transmit EUDCH packet data as described above, the number of physical channels transmitted in the uplink increases, causing an increase in a peak-to-average power ratio (PAPR) of an uplink transmission signal. It is general that the PAPR increases higher as the number of simultaneously transmitted physical channels increases higher.

Because the increase in the PAPR may increase distortion of transmission signals and an allowed Adjacent Channel Leakage power Ratio (ACLR), a radio frequency (RF) power amplifier in a UE requires power back-off. If the UE performs power back-off, the power back-off results in a reduction in reception power at a receiver in a Node B, causing an increase in error rate of received data.

Accordingly, in order to prevent the increase in PAPR, the UE intends to transmit the EUDCH over the existing physical channel such as a DPDCH on a time division basis, instead of transmitting the EUDCH on a separate physical channel. However, the process of transmitting the EUDCH over the existing physical channel on a time division basis causes an increase in implementation complexity.

Taking the problem into consideration, a WCDMA system has proposed a method for multiplying the physical channels by OVSF codes satisfying mutual orthogonality before transmission in the uplink. The physical channels multiplied by the OVSF codes can be distinguished in a Node B.

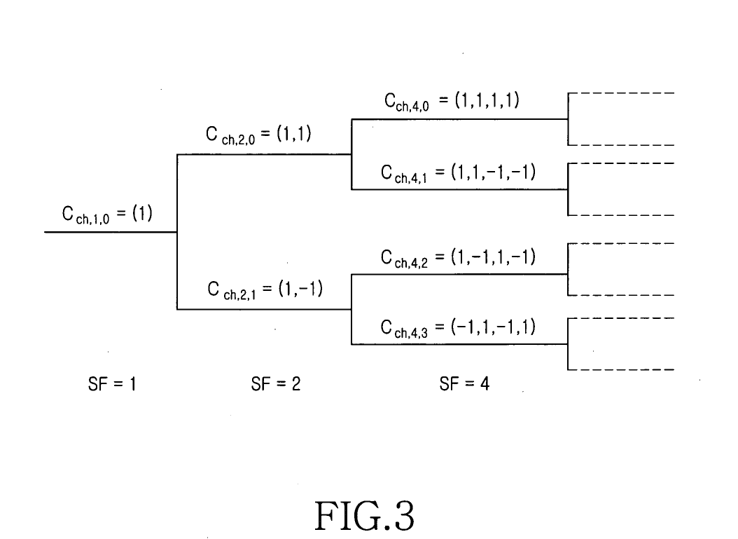

FIG. 3 is a diagram illustrating a tree structure for OVSF codes generally used in a WCDMA system.

Referring to FIG. 3, the OVSF codes can be simply generated in a calculation process of Equation (1) to Equation (3).

$$\begin{matrix}{C}_{ch , 1 , 0} = 1 , & Equation ( 1 ) \\ [ \begin{matrix}{C}_{ch , 2 , 0} \\ {C}_{ch , 2 , 1}\end{matrix} ] = [ \begin{matrix}{C}_{ch , 1 , 0} & {C}_{ch , 1 , 0} \\ {C}_{ch , 1 , 0} & - {C}_{ch , 1 , 0}\end{matrix} ] = [ \begin{matrix}1 & 1 \\ 1 & - 1\end{matrix} ] , & Equation ( 2 ) \\ [ \begin{matrix}{C}_{ch , {2}^{( n + 1 )} , 0} \\ {C}_{ch , {2}^{( n + 1 )} , 1} \\ {C}_{ch , {2}^{( n + 1 )} , 2} \\ {C}_{ch , {2}^{( n - 1 )} , 3} \\ ⋮ \\ {C}_{ch , {2}^{( n + 1 )} , {2}^{( n + 1 )} - 2} \\ {C}_{ch , {2}^{( n + 1 )} , {2}^{( n + 1 )} - 1}\end{matrix} ] = [ \begin{matrix}{C}_{ch , {2}^{n} , 0} & {C}_{ch , {2}^{n} , 0} \\ {C}_{ch , {2}^{n} , 0} & - {C}_{ch , {2}^{n} , 0} \\ {C}_{ch , {2}^{n} , 1} & {C}_{ch , {2}^{n} , 1} \\ {C}_{ch , {2}^{n} , 1} & - {C}_{ch , {2}^{n} , 1} \\ ⋮ & ⋮ \\ {C}_{ch , {2}^{n} , {2}^{n} - 1} & {C}_{ch , {2}^{n} , {2}^{n} - 1} \\ {C}_{ch , {2}^{n} , {2}^{n} - 1} & - {C}_{ch , {2}^{n} , {2}^{n} - 1}\end{matrix} ] & Equation ( 3 )\end{matrix}$$

As illustrated in FIG. 3, the OVSF codes are characterized in that orthogonality is secured between codes having the same spreading factor (SF).

In addition, for two codes having different SF values, if a code having a larger SF value cannot be generated from a code having a lower SF value using Equation (3), orthogonality is acquired between the two codes. A description thereof will be made below by way of example.

For SF=4, C_{ch,4,0}=(1,1,1,1) is orthogonal with C_{ch,2,1}=(1,−1) but is not orthogonal with C_{ch,2,0}=(1,1).

As another example, comparing SF=256 OVSF codes with the C_{ch,2,1}=(1,1), because OVSF codes with SF=0˜127 are generated from the C_{ch,2,1}=(1,1), orthogonality is not secured therebetween. That is, as a higher data rate is required, an OVSF code with a lower SF value is used, and when a plurality of physical channels are simultaneously transmitted, the OVSF codes should be allocated such that orthogonality should necessarily be secured therebetween.

Even though two physical channels use the same OVSF code, if they are separately transmitted through an I channel and a Q channel of a transmitter, a receiver can separate the two physical channel signals without mutual interference and demodulate the separated physical channel signals, because the signals transmitted on the I channel and the Q channel are carried by carriers having a 90°-phase difference.

As described above, an increase in uplink PAPR depends on the number of physical channels simultaneously transmitted in the uplink, a power ratio between physical channels, an OVSF code used for each physical channel, and I/Q channel allocation for each physical channel.

In addition, when several DPDCH channels are simultaneously transmitted or an uplink HS-DPCCH physical channel for High Speed Downlink Packet Access (HSDPA) service in the downlink is additionally transmitted, the current WCDMA system allocates appropriate OVSF codes and I/Q channels to DPDCH and HS-DPCCH channels in order to prevent the PAPR increase. For the DPDCH, the current Rel-5 WCDMA standard determines the maximum number of transmittable DPDCHs during initial call setup, and allocates as many OVSF codes as the determined number, for DPDCHs.

Therefore, in order for the current mobile communication system using limited radio resources to achieve a high EUDCH data rate, there is a demand for technology capable of efficiently allocating uplink OVSF codes to an E-DPDCH. That is, it is necessary to allocate as many OVSF codes available for the uplink as possible to the E-DPDCH channel in order to provide high-speed EUDCH data service.

### SUBSTANTIAL MATTER OF THE INVENTION

It is, therefore, an object of the present invention to provide a method for efficiently allocating OVSF codes for physical channels supporting an uplink in a mobile communication system.

It is another object of the present invention to provide a method for efficiently allocating OVSF codes in order to transmit packet data through an enhanced uplink in a mobile communication system.

It is further another object of the present invention to provide a method for reusing orthogonal codes allocated to physical channels supporting different services, for a physical channel for enhanced uplink packet transmission in a mobile communication system supporting an uplink.

In accordance with one aspect of the present invention, to achieve the above objects, there is provided a method for supporting different services by a user equipment (UE) sharing the same Orthogonal Variable Spreading Factor (OVSF) codes in a mobile communication system, the method comprising the steps of determining the maximum number of allocable channels considering the amount of packet data for a second service; determining the number of channels set up for a first service being different from the second service; and reallocating OVSF codes allocated for the channels set up for the first service, to channels determined for the second service, spreading packet data for the second service, and transmitting the spread packet data.

In accordance with another aspect of the present invention, to achieve the above objects, there is provided a method for transmitting enhanced packet data by a user equipment (UE) in a mobile communication system, the method comprising the steps of: determining the maximum number of enhanced uplink dedicated physical data channels (E-DPDCHs) that can be simultaneously transmitted; comparing the number of Orthogonal Variable Spreading Factor (OVSF) codes needed for an enhanced packet service with the determined number of the E-DPDCHs; and if the number of the E-DPDCHs is larger, reallocating OVSF codes allocated for dedicated physical channels (DPDCHs) over which the enhanced packet data is not transmitted at a transmission time, to the E-DPDCHs in the opposite order.

In accordance with further another aspect of the present invention, to achieve the above objects, there is provided a method for supporting an enhanced packet service by a user equipment (UE) in a mobile communication system, the method comprising the steps of: determining the maximum number of enhanced uplink dedicated physical data channels (E-DPDCHs) that can be simultaneously transmitted; comparing the number of Orthogonal Variable Spreading Factor (OVSF) codes needed for the enhanced packet service with the determined number of the E-DPDCHs; and if the number of the E-DPDCHs is larger, sequentially reallocating OVSF codes allocated for dedicated physical channels (DPDCHs) over which the enhanced packet data is not transmitted at a transmission time, to E-DPDCHs.

### CONSTRUCTION AND OPERATION OF THE INVENTION

Several preferred embodiments of the present invention will now be described in detail with reference to the annexed drawings. In the following description, a detailed description of known functions and configurations incorporated herein has been omitted for conciseness.

The present invention proposes a method in which OVSF codes and I/Q channels are dynamically used when an E-DPCCH and an E-DPDCH, which are a control channel and a data channel for transmission of EUDCH packet data, respectively, are transmitted in addition to the existing physical channels. A technique proposed by the present invention aims at minimizing signaling overhead additionally required in an uplink and maximizing transmission efficiency of EUDCH data through an E-DPDCH physical channel.

In addition, the present invention aims at maintaining backward compatibility with the existing Rel-99 and Rel-5 WCDMA standards, thereby preventing an influence on an allocation rule for the existing DPDCH, DPCCH and HS-DPCCH channels.

In the EUDCH service, because the EUDCH packet data requires a high data rate, a plurality of the E-DPDCH physical channels can be simultaneously transmitted. However, for the E-DPCCH, which is a control physical channel, a single E-DPCCH can be transmitted. Herein, the E-DPCCH transmits a buffer state of a UE, or transmits uplink transmission power, uplink transmission power margin and channel state information, which are information required by a Node B to estimate an uplink channel condition. In addition, the E-DPCCH transmits a EUDCH-Transport Format Indicator (E-TFI) for EUDCH service which is transmitted over the E-DPDCH. The E-DPDCH, a dedicated physical data channel for the EUDCH service, transmits packet data using a data rate determined based on scheduling information provided from the Node B.

Therefore, the present invention provides a method for dynamically allocating OVSF codes allocated to the DPDCH and the HS-DPCCH every TTI, thereby increasing the number of E-DPDCH channels which can be simultaneously transmitted.

In a first case, a code used for a DPDCH and a code used for an E-DPDCH are previously allocated.

That is, OVSF codes for DPDCHs are allocated considering the maximum number of transmittable DPDCH channels, determined during initial call setup as done in the current Rel-5 WCDMA standard, and then OVSF codes unallocated for other physical channels such as the DPDCH and the HS-DPCCH are allocated for E-DPDCHs. In other words, as many previously allocated codes for E-DPDCHs as the maximum number of transmittable E-DPDCH channels are selected every Transmission Time Interval (TTI), and used for E-DPDCH transmission. If a data rate of the E-DPDCH is not satisfied, the OVSF codes allocated to the DPDCH and the HS-DPCCH are additionally used for the E-DPDCH, thereby increasing the maximum number of transmittable E-DPDCHs.

In a second case, unlike in the first case, codes used for transmission of E-DPDCHs are not previously allocated, and the remaining codes unused for transmission of physical channels such as DPDCH, DPCCH and HS-DPCCH are used for transmission of E-DPDCHs every TTI. By doing so, it is possible to improve efficiency of physical channel codes used for E-DCH data transmission.

In the foregoing case, even though the numbers of E-DPDCH physical channels transmitted for different TTIs are equal to each other, OVSF codes used for E-DPDCHs are subject to change according to the number of DPDCH channels transmitted for a corresponding TTI.

In both of the two cases, in order to demodulate E-DPDCH data, it is necessary for a Node B to acquire OVSF code information used for E-DPDCH channels. To this end, it can be necessary for a UE to signal codes used for transmission of E-DPDCH channels to the Node B. The increase in the signaling overhead causes a reduction in uplink system capacity and cell coverage.

Therefore, the present invention proposes technology capable of dynamically using OVSF codes unused for other physical channels such as DPDCH and HS-DPCCH, for E-DPDCHs every TTI, while preventing an additional increase in the signaling overhead.

Accordingly, the present invention sets an E-TFI using only size (number of bits) information and channel coding information of a transmission EUDCH data block according to the foregoing two embodiments, thereby enabling a Node B to normally demodulate E-DPDCH data.

Table 1 illustrates I/Q channel and OVSF code allocation for E-DPDCHs when an HS-DPCCH is not set up.

TABLE 1

| Maximum Number | Maximum Number | |
|---|---|---|
| of Transmittable | of Transmittable | |
| DPDCHs | E-DPDCHs | E-DPDCH Allocation |
| 1 | 5 | (Q, SF, SF/4), (I, 4, 3), |
| | | (Q, 4, 3), (I, 4, 2), (Q, 4, |
| | | 2) |
| 2 | 4 | (I, SF, SF/2 + SF/4), (Q, 4, |
| | | 3), (I, 4, 2), (Q, 4, 2) |
| 3 | 3 | (Q, SF, SF/2 + SF/4), (I, 4, |
| | | 2), (Q, 4, 2) |
| 4 | 2 | (I, SF, SF/2), (Q, 4, 2) |
| 5 | 1 | (Q, SF, SF/2) |

As described above, in the current Rel-5 WCDMA standard where several DPDCH channels are transmitted, if SF_{DPDCH} is set to 4 according to a data rate, OVSF codes of (I, 4, 1), (Q, 4, 1), (I, 4, 3), (Q, 4, 3), (I, 4, 2) and (Q, 4, 2) can be sequentially used for the DPDCHs. Accordingly, a required number of the remaining codes except the codes previously allocated for DPDCHs among the 6 codes can be used for E-DPDCHs according to a UEDCH packet data rate considering the maximum number of transmittable DPDCH channels.

In Table 1, if the maximum number of transmittable DPDCHs is 1, a maximum of 5 codes can be used for E-DPDCH channels transmitting EUDCH data. In Table 1, 4, 8, 16, 32, 64, 128, 256 and 512 are available for SF_{E}_{_{—}}_{DPDCH}. That is, if SF_{E}_{_{—}}_{DPDCH} of an E-DPDCH is set to 4, an EUDCH transmits an E-DPDCH 1 in a Q channel using an OVSF code (4, 1) according to a data rate, and transmits an E-DPDCH2 in an I channel using an OVSF code (4, 3). In addition, the EUDCH transmits an E-DPDCH3 in the Q channel using an OVSF code (4, 3), and transmits an E-DPDCH4 in the I channel using an OVSF code (4, 2). Further, a fifth E-DPDCH can be additionally allocated such that it can be transmitted in the Q channel using an OVSF code (4, 2).

However, in Table 1, if a maximum of 1 DPDCH can be transmitted and an HS-DPCCH is set up with (Q, 256, 64), then four OVSF codes (I, SFE_DPCCH, SF_{E}_{_{—}}_{DPCCH}/2+SF_{E}_{_{—}}_{DPCCH}/4), (Q, 4, 3), (I, 4, 2) and (Q, 4, 2) are sequentially additionally allocated for E-DPDCHs according to a EUDCH data rate. Herein, in the Q channel, an OVSF code (4, 1) can be hardly used for an E-DPDCH, because the HS-DPCCH is allocated to (Q, 256, 64).

As described above, the maximum number of transmittable E-DPDCHs is determined based on the maximum number of transmittable DPDCHs and presence/absence of an HS-DPCCH. In addition, when the DPDCH is transmitted using multiple codes, the number of OVSF codes exclusively available for the E-DPDCH decreases, causing a reduction in the maximum number of transmittable E-DPDCHs. As a result, the EUDCH data rate is reduced.

In this regard, first and second embodiments of the present invention propose a method of reusing OVSF codes allocated to the DPDCH and the HS-DPCCH, for E-DPDCHs, thereby increasing the maximum number of transmittable E-DPDCHs.

### First Embodiment

A description will now be made of a method of using OVSF codes allocated to the DPDCH and the HS-DPCCH, for E-DPDCHs, according to a first embodiment of the present invention.

1) HS-DPCCH being not Setup

If the maximum number of transmittable DPDCH channels is 3 and an HS-DPCCH is not set up, then the DPDCHs can be multicode-transmitted using a maximum of three codes of (I, 4, 1), (Q, 4, 1) and (I, 4, 3). As can be seen in Table 1, OVSF codes available for E-DPDCHs include three codes of (Q, 4, 3), (I, 4, 2), (Q, 4, 2) used for enabling multicode transmission.

If an E-DPDCH fails to satisfy a data rate even though it uses three codes of (Q, 4, 3), (I, 4, 2), (Q, 4, 2) allocated thereto, codes allocated to the DPDCHs are reused for transmission of the E-DPDCH to satisfy the data rate. That is, a maximum of six E-DPDCH physical channels can be transmitted.

In this way, DPDCH codes are additionally used for transmission of E-DPDCHs as shown in Table 2 so that a Node B can normally demodulate both the E-DPDCHs and the DPDCHs.

TABLE 2

| Number of Transmission | DPDCH Codes Additionally |
|---|---|
| E-DPDCH | used by E-DPDCH |
| 4 | (I, 4, 3) |
| 5 | (I, 4, 3), (Q, 4, 1) |
| 6 | (I, 4, 3), (Q, 4, 1), (I, 4, 1) |

As illustrated in Table 2, the OVSF code allocation method in the first embodiment allocates OVSF codes for E-DPDCHs in the opposite order of allocation for DPDCHs.

For example, if the number of E-DPDCHs that should be simultaneously transmitted is 4, three codes of (Q, 4, 3), (I, 4, 2) and (Q, 4, 2) allocated for E-DPDCHs are sequentially used, and (I, 4, 3) is used for an E-DPDCH4 to be additionally transmitted, in the opposite order of OVSF codes allocated to the DPDCHs. Herein, the code (I, 4, 3) is a code allocated to the last third DPDCH channel when three DPDCHs are transmitted. That is, the present invention additionally allocates the OVSF code (I, 4, 3) having the lowest priority in the DPDCH to the E-DPDCH4, thereby satisfying a data rate of the E-DPDCH while maintaining orthogonality between the E-DPDCH and the DPDCH.

As another example, if the number of E-DPDCHs that should be simultaneously transmitted is 5, the code (I, 4, 3) allocated for a DPDCH and an additional code (Q, 4, 1) are allocated to the E-DPDCH4 and an E-DPDCH5.

However, in a TTI where the DPDCH is not transmitted, it is possible to transmit a maximum of six E-DPDCH channels in order of (Q, 4, 3), (I, 4, 2), (Q, 4, 2), (I, 4, 3), (Q, 4, 1) and (I, 4, 1) by selecting three codes of (I, 4, 1), (Q, 4, 1) and (I, 4, 3) sequentially allocated to the DPDCHs, in the opposite order of the allocation. A description will now be made of the case where SFE_DPDCH is 4.

2) HS-DPCCH being Set up with Code (Q, 256, 64)

If an HS-DPCCH uses a code (Q, 256, 64) and a DPDCH uses a code (I, SF, SF/4), then (Q, 4, 1) and (I, 4, 1) can be reused for transmission of E-DPDCHs in a TTI where the HS-DPCCH or DPDCH is not transmitted.

More specifically, an ACK/NACK signal for HSDPA service and CQI indicating uplink channel state information are carried by an HS-DPCCH. The ACK/NACK signal is transmitted only when an HSDPA packet is received in a downlink, and the CQI is transmitted at 2 ms-TTI periods determined during initial HSDPA service setup. Therefore, the HS-DPCCH channel can also be reused for transmission of the E-DPDCH. In particular, for the HS-DPCCH, because both a Node B and a UE correctly know transmission timing, it is simple to reuse codes for E-DPDCHs.

Therefore, if an E-DPDCH is additionally set up due to an unsatisfactory data rate after E-DPDCHs are allocated three codes of (Q, 4, 3), (I, 4, 2) and (Q, 4, 2), then an E-DPDCH channel is allocated considering whether an HS-DPCCH is used. In addition, OVSF codes are allocated in the opposite order of allocation of the codes unused for DPDCHs. In order to allow the E-DPDCH to reuse codes for the DPDCHs and the HS-DPCCH as described above, a Node B is required to correctly know the number of DPDCH and E-DPDCH physical channels transmitted from a UE. This should be guaranteed in order for the Node B to normally demodulate DPDCH and E-DPDCH data.

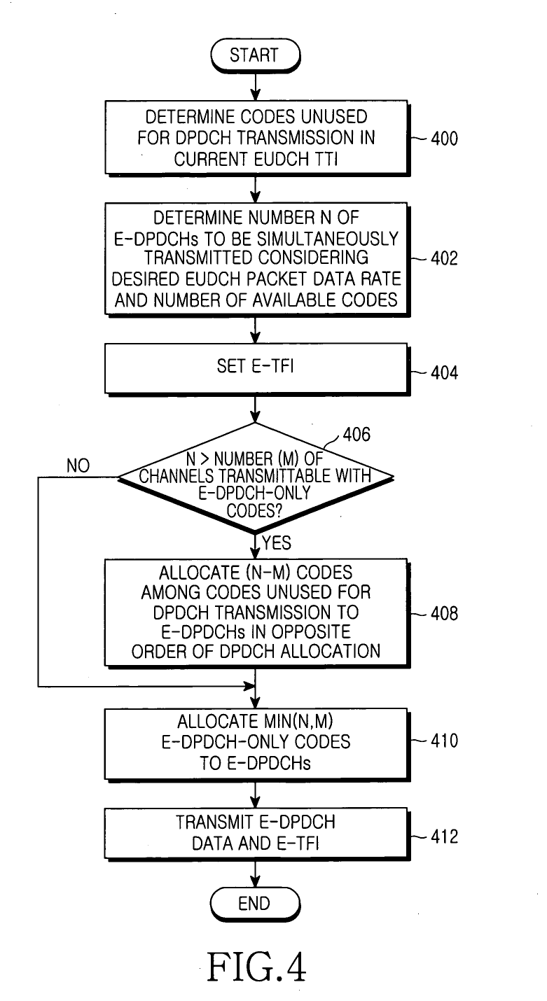

FIG. 4 is a flowchart illustrating a transmission operation of a UE reusing DPDCH codes according to the first embodiment of the present invention.

Referring to FIG. 4, if a UE desires to transmit EUDCH packet data at a high data rate, it requires a plurality of E-DPDCHs in proportion to the data rate in step 400. Therefore, the UE determines how many DPDCH channels have been transmitted in a TTI for which the corresponding EUDCH packet data will be transmitted, and determines DPDCH channel codes unused in the TTI.

In step 402, the UE determines the number N of E-DPDCH channels which satisfy a EUDCH packet data rate and will be transmitted simultaneously, considering even the codes unused for DPDCH transmission in the TTI.

In step 404, the UE sets an E-TFI so that a Node B can know the number of E-DPDCH channels transmitted in the TTI. In the foregoing DPDCH code reusing method, the E-TFI, like the existing DPDCH Transport Format Combination Indicator (TFCI), is enough to include size (number of bits) and channel coding information of a EUDCH data block being transmitted. A Node B can determine the number of transmitted E-DPDCH channels from the information, and can also determine OVSF codes used for E-DPDCH channels from the information.

In step 406, the UE determines whether the number N of E-DPDCH channels that will be simultaneously transmitted is larger than the number M of channels that can be transmitted using E-DPDCH-only OVSF codes. If it is determined in step 406 that the number N of E-DPDCH channels that will be simultaneously transmitted is larger than the number M of channels that can be transmitted using E-DPDCH-only OVSF codes, the UE proceeds to step 408.

In step 408, the UE allocates as many codes as the required number (N-M) of channels to E-DPDCHs among codes allocated to DPDCHs in the opposite order of codes allocation during DPDCH multicode transmission.

In step 410, the UE allocates E-DPDCH-only OVSF codes to E-DPDCHs. As described with reference to Table 1, if the maximum number of transmittable DPDCHs is 3, the UE additionally allocates codes to E-DPDCHs in sequence in the opposite order of allocation on three codes of (I, 4, 1), (Q, 4, 1) and (I, 4, 3) allocated to the DPDCHs, i.e., in the order of (I, 4, 3), (Q, 4, 1) and (I, 4, 1).

However, if the number N of E-DPDCH channels that will be simultaneously transmitted is smaller than the number M of channels that can be transmitted using E-DPDCH-only OVSF codes (N<M), the UE allocates N E-DPDCH-only codes to E-DPDCHs. In step 412, the UE transmits spread E-DPDCHs to the Node B using the determined OVSF codes. At this time, the UE transmits the E-TFI set in step 404 together. The set E-TFI is transmitted over an E-DPDCH or an E-DPCCH.

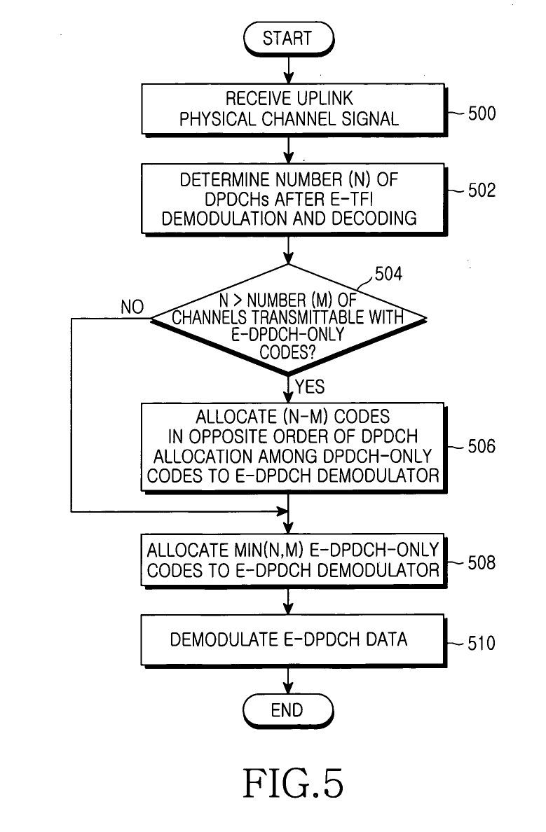

FIG. 5 is a flowchart illustrating a reception operation of a Node B reusing DPDCH codes according to the first embodiment of the present invention.

Referring to FIG. 5, in step 500, a Node B receives an uplink physical channel in the TTI. In step 502, the Node B first performs demodulation and decoding on an E-TFI to demodulate E-DPDCH data. Further, the Node B determines the number of E-DPDCH channels transmitted in a set TTI from the E-TFI. Also, the Node B can determine OVSF codes used for the received E-DPDCH channels based on the procedure described below.

In step 504, the Node B determines whether the number N of the E-DPDCH channels is larger than the number M of OVSF codes exclusively allocated for E-DPDCH channels. If it is determined in step 504 that the N is larger than the M, the Node B proceeds to step 506.

In step 506, the Node B allocates codes corresponding to the E-DPDCHs to an E-DPDCH data demodulator based on an OVSF code reusing rule for E-DPDCHs according to the first embodiment of the present invention, determining that OVSF codes are allocated to the E-DPDCHs in the opposite order of code allocation for DPDCH multicode transmission.

In step 508, the Node B allocates E-DPDCH-only codes used for E-DPDCH transmission to the E-DPDCH data demodulator. In addition, the Node B allocates DPDCH codes reused in the opposite order to the E-DPDCH data demodulator. Therefore, the Node B can determine data transmitted over the E-DPDCHs. However, if it is determined in step 504 that N<M, the Node B allocates the corresponding codes to the E-DPDCH data demodulator in step 508 because it can previously determine E-DPDCH codes used for E-DPDCHs based on a predetermined rule. That is, as N<M, the Node B demodulates E-DPDCH signals in the E-DPDCH data demodulator using the allocated OVSF codes in step 510, determining that a UE performs transmission using E-DPDCH-only OVSF codes.

For demodulation of DPDCHs, the Node B can determine the number of DPDCH channels transmitted by the UE, by demodulating a TFCI of a DPDCH transmitted over a DPCCH. Based on an OVSF code allocation rule for the DPDCH, the Node B determines OVSF codes used for DPDCH transmission and can normally demodulate DPDCH channels. That is, the UE and the Node B are not affected in transmitting and demodulating DPDCHs, respectively, because the UE additionally allocates OVSF codes to E-DPDCHs while maintaining the DPDCH code allocation rule.

With the use of the foregoing DPDCH code reusing method, the Node B can acquire code information used for E-DPDCHs without demodulating TFCI information of the DPDCH, thereby preventing time delay in E-DPDCH demodulation and HARQ operation.

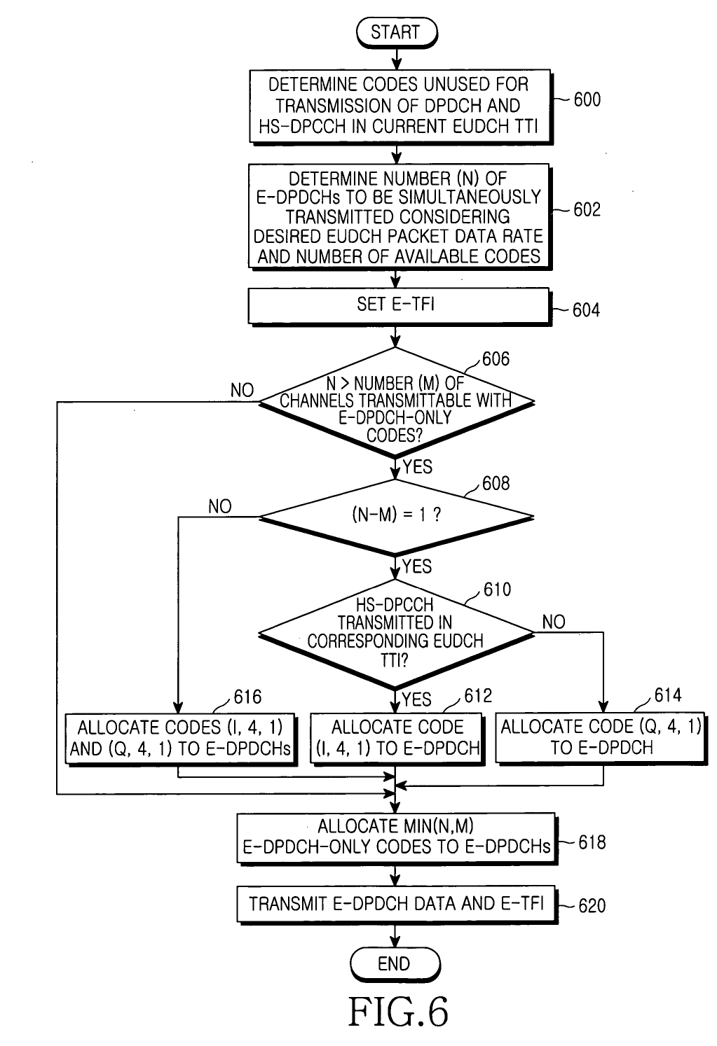

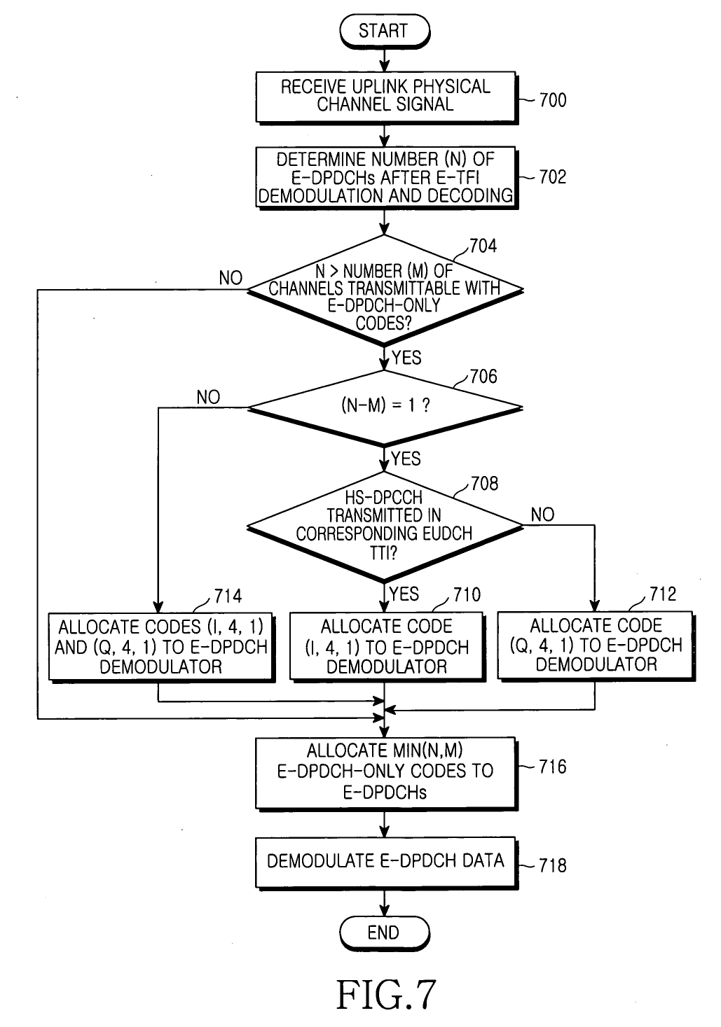

With reference to FIGS. 6 and 7, a description will now be made of a transmission operation of a UE and a reception operation of a Node B in the case where DPDCH and HS-DPCCH codes are reused for E-DPDCHs.

FIG. 6 is a flowchart illustrating a transmission operation of a UE reusing HS-DPCCH codes according to an embodiment of the present invention.

Referring to FIG. 6, in step 600, a UE determines whether an HS-DPCCH and a DPDCH are transmitted in a corresponding EUDCH TTI, for code reusing. That is, the UE determines whether codes unused for DPDCH and HS-DPCCH transmission and the HS-DPCCH are transmitted in the TTI.

In step 602, the UE determines the number N of E-DPDCH channels which satisfy a EUDCH packet data rate and will be transmitted simultaneously, considering even the codes unused for DPDCH transmission in the TTI. In step 604, the UE sets an E-TFI so that a Node B can know the number of E-DPDCH channels transmitted in the TTI.

In step 606, the UE determines whether the number N of E-DPDCH channels that will be simultaneously transmitted is larger than the number M of channels that can be transmitted using E-DPDCH-only OVSF codes. If it is determined in step 606 that the number N of E-DPDCH channels that will be simultaneously transmitted is larger than the number M of channels that can be transmitted using E-DPDCH-only OVSF codes, the UE proceeds to step 608.

In step 608, the UE determines whether it should additionally use one code for an E-DPDCH. If so, the UE proceeds to step 610.

In step 610, the UE determines whether an HS-DPCCH is transmitted in a corresponding EUDCH TTI. If the HS-DPCCH is not transmitted, the UE proceeds to step 614. In step 614, the UE additionally allocates a code (Q, 4, 1) allocated to the HS-DPCCH, for an E-DPDCH. That is, the UE reuses the code (Q, 4, 1) allocated to the HS-DPCCH not being serviced in the TTI, for the E-DPDCH. However, if it is determined in step 610 that the HS-DPCCH is simultaneously transmitted in the TTI, the UE proceeds to step 612. In step 612, the UE additionally allocates a code (I, 4, 1) allocated to a DPCCH for an E-DPDCH, determining that no DPDCH has been transmitted.

If it is determined in step 608 that the UE should additionally allocate two OVSF codes for E-DPDCHs, i.e., an HS-DPCCH and a DPDCH are not being serviced in the TTI, then the UE additionally allocates in step 616 a code (I, 4, 1) allocated to the DPDCH and a code (Q, 4, 1) allocated to the HS-DPCCH, to E-DPDCHs.

If it is determined in step 606 that the number N of E-DPDCH channels that will be simultaneously transmitted is smaller than the number M of channels that can be transmitted using E-DPDCH-only OVSF codes (N<M), i.e., if a data rate is satisfied using the E-DPDCH-only OVSF codes, then the UE proceeds to step 618 where it additionally allocates N required E-DPDCH-only codes to E-DPDCHs. In step 620, the UE transmits E-DPDCHs and a preset E-TFI together using the determined OVSF codes.

FIG. 7 is a flowchart illustrating a reception operation of a Node B reusing HS-DPCCH codes according to an embodiment of the present invention.

Referring to FIG. 7, in step 700, a Node B receives an uplink physical channel in the TTI. In step 702, the Node B performs demodulation and decoding on an E-TFI to demodulate received E-DPDCH data, and determines the number of E-DPDCH channels transmitted in the TTI from the E-TFI.

In step 704, the Node B determines whether the number N of the E-DPDCH channels is larger than the number M of OVSF codes exclusively allocated for E-DPDCH channels. If it is determined in step 704 that the N is larger than the M, the Node B proceeds to step 706.

In step 706, the Node B determines whether the number N of transmitted E-DPDCH channels is larger than the number M of codes exclusively allocated for E-DPDCH channels. If the N is larger than the M by one, the Node B proceeds to step 708. In step 708, the Node B determines whether an HS-DPCCH has been simultaneously transmitted, from a transmission timing set value for the HS-DPCCH.

If the HS-DPCCH has not been simultaneously transmitted, the Node B proceeds to step 712. In step 712, the Node B additionally demodulates E-DPDCH data using a code (Q, 4, 1) used for the E-DPDCH instead of the HS-DPCCH.

If it is determined in step 708 that the HS-DPCCH has been simultaneously transmitted in the E-DPDCH TTI, the Node B proceeds to step 710 where it additionally demodulates E-DPDCH data using a code (I, 4, 1) used for the E-DPDCH instead of the DPCCH.

However, after the Node B demodulates the E-TFI, if it is determined in step 706 that the number N of E-DPDCH channels is larger by two than the number M of codes exclusively allocated for the E-DPDCH channels, the Node B proceeds to step 714. This means that the HS-DPCCH and the DPDCH are not serviced in the TTI. Therefore, in step 714, the Node B additionally demodulates E-DPDCH data using codes (I, 4, 1) and (Q, 4, 1) used for the E-DPDCHs instead of the HS-DPCCH and the DPDCH. That is, the Node B additionally demodulates the E-DPDCH data using the used codes (I, 4, 1) and (Q, 4, 1), determining from the E-TFI that a UE additionally uses the codes (I, 4, 1) and (Q, 4, 1). As described above, this is available only when both the HS-DPCCH and the DPDCH are not transmitted in the TTI.

In step 716, the Node B can determine E-DPDCH codes used for E-DPDCHs based on a predetermined OVSF code allocation rule. In step 718, the Node B can demodulate E-DPDCH data using the E-DPDCH-only codes.

As described above, the first embodiment provides a technique for additionally reusing OVSF codes allocated to DPDCHs and an HS-DPCCH, to E-DPDCHs when E-DPDCH-only OVSF codes are allocated during initial call setup.

### Second Embodiment

A description will now be made of a technique for dynamically allocating, to E-DPDCHs, remaining codes unused for transmission of physical channels such as DPDCH, DPCCH and HS-DPCCH every TTI, instead of initially allocating E-DPDCH-only OVSF codes, according to the second embodiment. In this case, a Node B can normally demodulate E-DPDCH data with only EUDCH data block size and channel coding information carried by an E-TFI without the need for directly signaling OVSF code and I/Q channel information used for E-DPDCH transmission to the Node B.

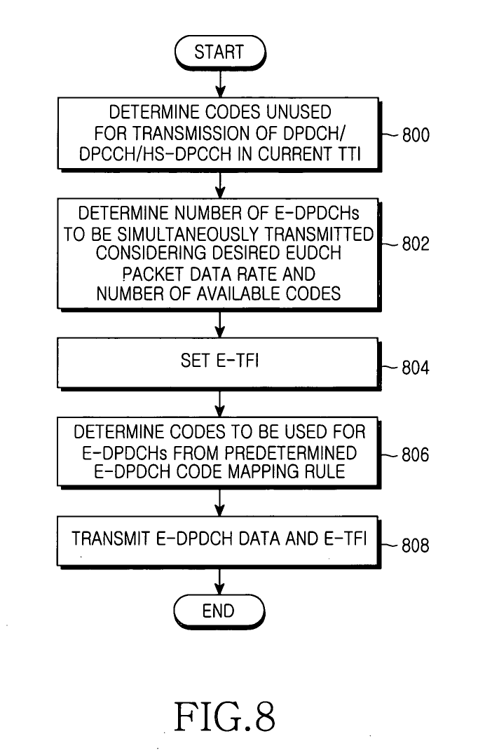

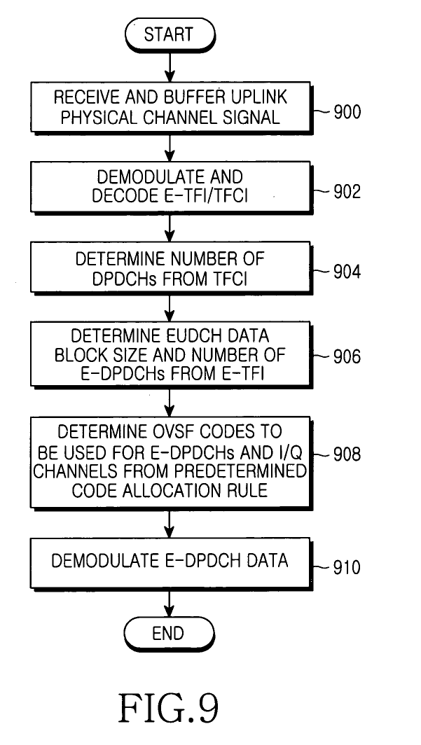

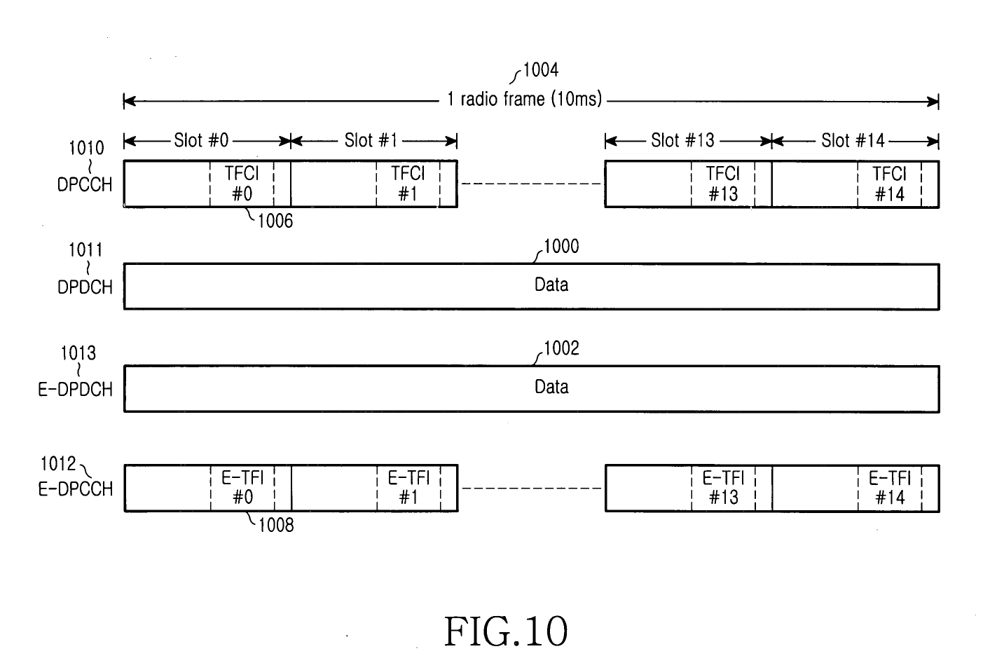

FIG. 8 illustrates a UE's transmission operation of dynamically allocating E-DPDCH codes according to the second embodiment of the present invention. FIG. 9 illustrates a procedure for demodulating, by a Node B, E-DPDCH data using dynamically allocated E-DPDCH codes. This is a technique chiefly used when a DPDCH 1000 and an E-DPDCH 1002 are equal to each other in frame length and timing as illustrated in FIG. 10.

In FIG. 10, a DPCCH 1010 and an E-DPCCH 1012 have a 10-ms frame length 1004, and a TFCI 1006 indicating size and channel coding information of a data block transmitted through the DPDCH 1011 is transmitted over the DPCCH 1010.

In addition, an E-TFI 1008 indicating size and channel coding information of a data block transmitted through an E-DPDCH 1013 is transmitted through a corresponding field of the E-DPCCH 1012. Although it is assumed that the E-TFI information is transmitted through the E-DPCCH channel, the E-TFI information can also be transmitted through the E-DPDCH. Even in this case, the following description can be applied in the same way. It is general herein that the TFCI and E-TFI information is transmitted over 15 slots within one frame.

When the E-DPDCH and the DPDCH are equal to each other in transmission timing as described above, it is possible to allocate as many UE's unused OVSF code resources as possible for E-DPDCH transmission, and a Node B can simply demodulate data transmitted over the E-DPDCH, preventing an increase in uplink signaling overhead.

That is, a UE transmits size and channel coding information of a EUDCH data block to a Node B using the E-TFI without the need for directly signaling OVSF code and I/Q channel information used for E-DPDCH channels to the Node B. Therefore, the Node B can normally demodulate E-DPDCH data with only the E-TFI.

Herein, OVSF code and I/Q channel allocation for the E-DPDCH is determined based on the following factors.

1. The number of DPDCH channels transmitted in a corresponding TTI and OVSF codes.

2. Setup/non-setup of an HS-DPCCH.

3. A size of a EUDCH data block being transmitted, and the number of E-DPDCH channels.

Table 3 and Table 4 indicate which OVSF code and I/Q channel are used by DPDCH and E-DPDCH channels according to the number of the DPDCH and E-DPDCH channels being transmitted in the current TTI. The code allocation rules of Table 3 and Table 4 are defined to use OVSF codes and I/Q channels unused by the DPDCH and the HS-DPCCH in a corresponding TTI, for E-DPDCHs. It is noted from Table 3 and Table 4 that OVSF codes and I/Q channels used by E-DPDCHs are changed according to the number of DPDCH channels transmitted for each TTI. Herein, 4, 8, 16, 32, 64, 128, 256 and 512 are available for SF_{E}_{_{—}}_{DPDCH}.

In order for the E-DPDCH code allocation rule to maintain compatibility with the existing standard, the DPDCH and HS-DPCCH code allocation rule follows the current WCDMA standard. Table 3 corresponds to a case where an HS-DPCCH is not set up, or the HS-DPCCH is set up and the maximum number of transmittable DPDCHs is 2 or larger.

TABLE 3

| Number of | Number of | |
|---|---|---|
| DPDCHs | E-DPDCHs | Codes Used for DPDCH/E-DPDCH |
| 0 | 1 | None/ |
| | | (I, SF_{E-DPDCH}, SF_{E-DPDCH}/4) |
| | 2 | None/ |
| | | (I, 4, 1), (Q, 4, 1) |
| | 3 | None/ |
| | | (I, 4, 1), (Q, 4, 1), (I, 4, 3) |
| | 4 | None/ |
| | | (I, 4, 1), (Q, 4, 1), (I, 4, 3), (Q, 4, 3) |
| | 5 | None/ |
| | | (I, 4, 1), (Q, 4, 1), (I, 4, 3), (Q, 4, 3), (I, 4, 2) |
| | 6 | None/ |
| | | (I, 4, 1), (Q, 4, 1), (I, 4, 3), (Q, 4, 3), (I, 4, 2), |
| | | (Q, 4, 2) |
| 1 | 1 | (I, SF_{DPDCH}, SF_{DPDCH/4})/ |
| | | (Q, SF_{E-DPDCH}, SF_{E-DPDCH}/4) |
| | 2 | (I, SF_{DPDCH}, SF_{DPDCH/4})/ |
| | | (Q, 4, 1), (I, 4, 3) |
| | 3 | (I, SF_{DPDCH}, SF_{DPDCH/4})/ |
| | | (Q, 4, 1), (I, 4, 3), (Q, 4, 3) |
| | 4 | (I, SF_{DPDCH}, SF_{DPDCH/4})/ |
| | | (Q, 4, 1), (I, 4, 3), (Q, 4, 3), (I, 4, 2) |
| | 5 | (I, SF_{DPDCH}, SF_{DPDCH/4})/ |
| | | (Q, 4, 1), (I, 4, 3), (Q, 4, 3), (I, 4, 2), (Q, 4, 2) |
| 2 | 1 | (I, 4, 1), (Q, 4, 1)/ |
| | | (I, SF_{E-DPDCH}, SF_{E-DPDCH}/4 + SF_{E-DPDCH}/2) |
| | 2 | (I, 4, 1), (Q, 4, 1)/ |
| | | (I, 4, 3), (Q, 4, 3) |
| | 3 | (I, 4, 1), (Q, 4, 1)/ |
| | | (I, 4, 3), (Q, 4, 3), (I, 4, 2) |
| | 4 | (I, 4, 1), (Q, 4, 1)/ |
| | | (I, 4, 3), (Q, 4, 3), (I, 4, 2), (Q, 4, 2) |
| 3 | 1 | (I, 4, 1), (Q, 4, 1), (I, 4, 3)/ |
| | | (Q, SF_{E-DPDCH}, SF_{E-DPDCH}/4 + SF_{E-DPDCH}/2) |
| | 2 | (I, 4, 1), (Q, 4, 1), (I, 4, 3)/ |
| | | (Q, 4, 3), (I, 4, 2) |
| | 3 | (I, 4, 1), (Q, 4, 1), (I, 4, 3)/ |
| | | (Q, 4, 3), (I, 4, 2), (Q, 4, 2) |
| 4 | 1 | (I, 4, 1), (Q, 4, 1), (I, 4, 3), (Q, 4, 3)/ |
| | | (I, SF_{E-DPDCH}, SF_{E-DPDCH}/2) |
| | 2 | (I, 4, 1), (Q, 4, 1), (I, 4, 3), (Q, , 3)/ |
| | | (I, 4, 2), (Q, 4, 2) |
| 5 | 1 | (I, 4, 1), (Q, 4, 1), (I, 4, 3), (Q, 4, 3), (I, 4, 2)/ |
| | | (Q, 4, 2) |

Table 4 represents a case where an HS-DPCCH is set up and the maximum number of transmittable DPDCHs is 1.

TABLE 4

| Number of | Number of | |
|---|---|---|
| DPDCHs | E-DPDCHs | Codes Used for DPDCH/E-DPDCH |
| 1 | 1 | (I, SF_{DPDCH}, SF_{DPDCH}/4)/ |
| | | (I, SF_{DPDCH}, SF_{DPDCH}/4 + SF_{DPDCH}/2) |
| | 2 | (I, SF_{DPDCH}, SF_{DPDCH}/4)/ |
| | | (I, 4, 3), (Q, 4, 3) |
| | 3 | (I, SF_{DPDCH}, SF_{DPDCH}/4)/ |
| | | (I, 4, 3), (Q, 4, 3), (I, 4, 2) |
| | 4 | (I, SF_{DPDCH}, SF_{DPDCH}/4)/ |
| | | (I, 4, 3), (Q, 4, 3), (I, 4, 2), (Q, 4, 2) |
| 0 | 1 | None/ |
| | | (I, SF_{E-DPDCH}, SF_{E-DPDCH}/4) |
| | 2 | None/ |
| | | (I, 4, 1), (I, 4, 3) |
| | 3 | None/ |
| | | (I, 4, 1), (I, 4, 3), (Q, 4, 3) |
| | 4 | None/ |
| | | (I, 4, 1), (I, 4, 3), (Q, 4, 3), (I, 4, 2) |
| | 5 | None/ |
| | | (I, 4, 1), (I, 4, 3), (Q, 4, 3), (I, 4, 2), (Q, 4, 2) |

The reason why the two separate cases are provided is because in the case of Table 4 where the maximum number of transmittable DPDCHs is 1, an HS-DPCCH is transmitted on a Q channel using an OVSF code (256, 64), so that an E-DPDCH cannot be transmitted on the Q channel using an OVSF code (4, 1). On the contrary, in the case where the maximum number of transmittable DPDCHs is 2 or larger, an HS-DPCCH uses a code (I, 256, 1) or (Q, 256, 32), so that the same E-DPDCH code allocation rule can be used as that used in the case where the HS-DPCCH is not set up.

Table 5 and Table 6, unlike Table 3 and Table 4, represent the cases where I/Q channels for the E-DPDCH are allocated in the opposite order. That is, in a basic principle, for an OVSF code with the same index, an E-DPDCH is first allocated to a Q channel and next allocated to an I channel.

TABLE 5

| Number of | Number of | |
|---|---|---|
| DPDCHs | E-DPDCHs | Codes Used for DPDCH/E-DPDCH |
| 0 | 1 | None/ |
| | | (Q, SF_{E-DPDCH}, SF_{E-DPDCH}/4) |
| | 2 | None/ |
| | | (Q, 4, 1), (I, 4, 1) |
| | 3 | None/ |
| | | (Q, 4, 1), (I, 4, 1), (Q, 4, 3) |
| | 4 | None/ |
| | | (Q, 4, 1), (I, 4, 1), (Q, 4, 3), (I, 4, 3) |
| | 5 | None/ |
| | | (Q, 4, 1), (I, 4, 1), (Q, 4, 3), (I, 4, 3), (Q, 4, 2) |
| | 6 | None/ |
| | | (Q, 4, 1), (I, 4, 1), (Q, 4, 3), (I, 4, 3), (Q, 4, 2), |
| | | (I, 4, 2) |
| 1 | 1 | (I, SF_{DPDCH}, SF_{DPDCH}/4)/ |
| | | (Q, SF_{E-DPDCH}, SF_{E-DPDCH}/4) |
| | 2 | (I, SF_{DPDCH}, SF_{DPDCH}/4)/ |
| | | (Q, 4, 1), (Q, 4, 3) |
| | 3 | (I, SF_{DPDCH}, SF_{DPDCH}/4)/ |
| | | (Q, 4, 1), (Q, 4, 3), (I, 4, 3) |
| | 4 | (I, SF_{DPDCH}, SF_{DPDCH}/4)/ |
| | | (Q, 4, 1), (Q, 4, 3), (I, 4, 3), (Q, 4, 2) |
| | 5 | (I, SF_{DPDCH}, SF_{DPDCH}/4)/ |
| | | (Q, 4, 1), (Q, 4, 3), (I, 4, 3), (Q, 4, 2), (I, 4, 2) |
| 2 | 1 | (I, 4, 1), (Q, 4, 1)/ |
| | | (Q, SF_{E-DPDCH}, SF_{E-DPDCH}/4 + SF_{E-DPDCH}/2) |
| | 2 | (I, 4, 1), (Q, 4, 1)/ |
| | | (Q, 4, 3), (I, 4, 3) |
| | 3 | (I, 4, 1), (Q, 4, 1)/ |
| | | (Q, 4, 3), (I, 4, 3), (Q, 4, 2) |
| | 4 | (I, 4, 1), (Q, 4, 1)/ |
| | | (Q, 4, 3), (I, 4, 3), (Q, 4, 2), (I, 4, 2) |
| 3 | 1 | (I, 4, 1), (Q, 4, 1), (I, 4, 3)/ |
| | | (Q, 4, SF_{E-DPDCH}, SF_{E-DPDCH}/4 + SF_{E-DPDCH}/2) |
| | 2 | (I, 4, 1), (Q, 4, 1), (I, 4, 3)/ |
| | | (Q, 4, 3), (Q, 4, 2) |
| | 3 | (I, 4, 1), (Q, 4, 1), (I, 4, 3)/ |
| | | (Q, 4, 3), (Q, 4, 2), (I, 4, 2) |
| 4 | 1 | (I, 4, 1), (Q, 4, 1), (I, 4, 3), (Q, 4, 3)/ |
| | | (Q, SF_{E-DPDCH}, SF_{E-DPDCH}/2) |
| | 2 | (I, 4, 1), (Q, 4, 1), (I, 4, 3), (Q, 4, 3)/ |
| | | (Q, 4, 2), (I, 4, 2) |
| 5 | 1 | (I, 4, 1), (Q, 4, 1), (I, 4, 3), (Q, 4, 3), (I, 4, 2)/ |
| | | (Q, 4, 2) |

TABLE 6

| Number of | Number of | |
|---|---|---|
| DPDCHs | E-DPDCHs | Codes Used for DPDCH/E-DPDCH |
| 0 | 1 | None/ |
| | | (I, SF_{E-DPDCH}, SF_{E-DPDCH}/4) |
| | 2 | None/ |
| | | (I, 4, 1), (Q, 4, 3) |
| | 3 | None/ |
| | | (I, 4, 1), (Q, 4, 3), (I, 4, 3) |
| | 4 | None/ |
| | | (I, 4, 1), (Q, 4, 3), (I, 4, 3), (Q, 4, 2) |
| | 5 | None/ |
| | | (I, 4, 1), (Q, 4, 3), (I, 4, 3), (Q, 4, 2), (I, 4, 2) |
| 1 | 1 | (I, SF_{DPDCH}, SF_{DPDCH/4})/ |
| | | (Q, SF_{E-DPDCH}, SF_{E-DPDCH}/4 + SF_{E-DPDCH}/2) |
| | 2 | (I, SF_{DPDCH}, SF_{DPDCH/4})/ |
| | | (Q, 4, 3), (I, 4, 3) |
| | 3 | (I, SF_{DPDCH}, SF_{DPDCH/4})/ |
| | | (Q, 4, 3), (I, 4, 3), (Q, 4, 2) |
| | 4 | (I, SF_{DPDCH}, SF_{DPDCH/4})/ |
| | | (Q, 4, 3), (I, 4, 3), (Q, 4, 2), (I, 4, 2) |

In Table 5 and Table 6, SF_{DPDCH} and SF_{E-DPDCH} can have values of 4, 8, 16, 32, 64, 128, 256 and 512. For an OVSF code with the same index, the E-DPDCH is first allocated to a Q channel and additionally allocated to an I channel.

In Table 5, when the maximum number of transmittable DPDCHs is 0 and the number of E-DPDCHs is 1, an OVSF code (4, 1) is allocated to the E-DPDCH and transmitted in a Q channel. In this case, if the number of E-DPDCHs becomes 2 due to additional allocation of one channel to satisfy a data rate, an OVSF code (4, 1) is additionally allocated to an I channel. In Table 5, when the maximum number of transmittable DPDCHs is 1 and two E-DPDCHs are transmitted, (Q, 4, 1) and (I, 4, 3) are used for the E-DPDCHs.

In Table 6, when the maximum number of transmittable DPDCHs is 1 and there is an HS-DPCCH, an E-DPDCH cannot use an OVSF code (Q, SF_{E-DPDCH}, SF_{E-DPDCH}/4) because the HS-DPCCH uses (Q, 256, 64). In a TTI where no DPDCH is transmitted and 2 E-DPDCHs are transmitted, the E-DPDCHs use codes (I, 4, 1) and (Q, 4, 3) instead of an OVSF code (Q, 4, 1). OVSF codes for E-DPDCHs, which are changed according to the number of transmittable DPDCHs every TTI can be determined by a Node B by demodulating a TFCI of a DPDCH and recognizing the number of transmittable DPDCHs.

FIG. 8 is a flowchart illustrating a transmission operation of a UE according to the second embodiment of the present invention.

Referring to FIG. 8, in step 800, a UE determines how many DPDCH channels are transmitted in a TTI where corresponding EUDCH packet data is to be transmitted, and determines codes available in the TTI for E-DPDCH transmission.

In step 802, the UE determines the number of E-DPDCH channels to be simultaneously transmitted, considering a required EUDCH data rate and available OVSF code resources in the TTI. If the number of DPDCH channels transmitted in the TTI is small, the number of transmittable E-DPDCH channels will be large.

In step 804, the UE sets an E-TFI based on the determined EUDCH data rate.

In step 806, the UE determines OVSF codes and I/Q channels to be applied to E-DPDCH channels according to Table 3 and Table 4, or Table 5 and Table 6, considering the determined data rate and the determined number of E-DPDCH channels, and the number of DPDCH channels.

For example, if it is assumed that the number of DPDCH channels to be transmitted in the current TTI is 1, the number of E-DPDCH channels is 3, and an HS-DPCCH is set up, it can be understood from Table 3 that a DPDCH should be transmitted using a code (I, SF_{DPDCH}, SF_{DPDCH}/4) and E-DPDCHs should be transmitted using (Q, 4, 1), (I, 4, 3) and (Q, 4, 3).

As another example, if it is assumed that the number of DPDCH channels to be transmitted in the current TTI is 1, the number of E-DPDCH channels is 3, and an HS-DPCCH is not set up, it can be understood from Table 5 that a DPDCH should be transmitted using a code (I, SF_{DPDCH}, SF_{DPDCH}/4) and E-DPDCHs should be transmitted using (Q, 4, 1), (Q, 4, 3) and (I, 4, 3). As further another example, if it is assumed that the number of DPDCH channels to be transmitted in the current TTI is 1, the number of E-DPDCH channels is 3, and an HS-DPCCH is set up, it can be understood from Table 6 that E-DPDCHs are allocated (Q, 4, 3), (I, 4, 3) and (Q, 4, 2) because the HS-DPCCH uses a code (Q, 256, 64).

In step 808, the UE transmits uplink physical channels such as the DPDCH and the E-DPDCH. The physical channels are equal to each other in frame length and transmission timing as illustrated in FIG. 10.

FIG. 9 is a flowchart illustrating a reception operation a Node B according to the second embodiment of the present invention.

Referring to FIG. 9, in step 900, a Node B stores an uplink signal received in the current TTI in a buffer chip by chip. At the same time, the Node B performs demodulation and decoding on an E-TFI and a TFCI in step 902. By decoding the E-TFI and the TFCI, the Node B can acquire size and channel coding information of a data block transmitted through the E-DPDCH and the DPDCH. If, unlike those illustrated in FIG. 10, the E-TFCI, E-DPDCH and DPDCH are not equal to each other in transmission timing, the Node B should delay E-DPDCH demodulation until it completely receives TFCI information of the DPDCH. In steps 904 and 906, the Node B determines the number of DPDCH and E-DPDCH channels transmitted in the TTI, from the information.

In step 908, the Node B can determine OVSF codes and I/Q channels of E-DPDCHs, used for the E-DPDCHs according to a code allocation rule defined based on the number of transmitted DPDCH and E-DPDCH channels and data rate information.

In step 910, the Node B demodulates EUDCH data transmitted through the E-DPDCH channels.

### EFFECT OF THE INVENTION

As described above, the present invention proposes a method for dynamically allocating OVSF codes for DPDCHs and an HS-DPCCH to E-DPDCHs every TTI to provide a higher data rate in supporting EUDCH service by a UE. In addition, the present invention additionally allocates OVSF codes to E-DPDCHs according to whether the HS-DPCCH is transmitted or not, thereby supporting a higher data rate. Accordingly, the UE can use as many available OVSF codes as possible for EUDCH data transmission, thereby improving a EUDCH data rate. While the invention has been shown and described with reference to a certain preferred embodiment thereof, it will be understood by those skilled in the art that various changes in form and details may be made therein without departing from the spirit and scope of the invention as defined by the appended claims.

1. A method for supporting different services by a user equipment (UE) sharing the same Orthogonal Variable Spreading Factor (OVSF) codes in a mobile communication system, the method comprising the steps of:
determining the maximum number of allocable channels considering the amount of packet data for a second service;
determining the number of channels set up for a first service being different from the second service; and
reallocating OVSF codes allocated for the channels set up for the first service, to channels determined for the second service, spreading packet data for the second service, and transmitting the spread packet data.

2. The method of claim 1, wherein the second service is a service supporting enhanced packet data.

3. The method of claim 1, wherein the first service is a service supporting high-speed downlink packet data, or a service supporting uplink packet data.

4. The method of claim 1, wherein the UE reallocates OVSF codes allocated for channels for supporting high-speed downlink packet data to channels for transmitting enhanced packet data, and transmits the enhanced packet data.

5. The method of claim 1, wherein the UE reallocates the OVSF codes in the opposite order of OVSF codes allocated for channels for supporting uplink packet data to channels for transmitting enhanced uplink data, and transmits enhanced packet data.

6. The method of claim 1, wherein the UE sequentially reallocates OVSF codes except OVSF codes allocated for channels for supporting uplink packet data to channels for transmitting enhanced uplink data, and transmits enhanced packet data.

7. A method for transmitting enhanced packet data by a user equipment (UE) in a mobile communication system, the method comprising the steps of:
determining the maximum number of enhanced uplink dedicated physical data channels (E-DPDCHs) that can be simultaneously transmitted;
comparing the number of Orthogonal Variable Spreading Factor (OVSF) codes needed for an enhanced packet service with the determined number of the E-DPDCHs; and
if the number of the E-DPDCHs is larger, reallocating OVSF codes allocated for dedicated physical channels (DPDCHs) over which the enhanced packet data is not transmitted at a transmission time, to the E-DPDCHs in the opposite order.

8. The method of claim 7, wherein the step of reallocating the OVSF codes comprises the steps of:
allocating OVSF codes in an order of (Q, 4, 3), (I, 4, 2) and (Q, 4, 2), the order being determined for the E-DPDCHs; and
if E-DPDCHs are additionally transmitted, reallocating OVSF codes in an order of (I, 4, 1), (Q, 4, 1) and (I, 4, 3), determined for the DPDCHs, to the E-DPDCHs in the opposite order.

9. The method of claim 7, further comprising the step of transmitting to a Node B a control channel including transport format information indicating the maximum number of transmittable E-DPDCHs, and the E-DPDCHs to which OVSF codes are allocated in the opposite order of the DPDCHs.

10. A method for supporting an enhanced packet service by a Node B in a mobile communication system, the method comprising the steps of:
receiving a control channel including transport format information indicating the maximum number of transmittable enhanced data channels (E-DPDCHs), and the E-DPDCHs;
determining whether the number of the E-DPDCHs is larger than the number of Orthogonal Variable Spreading Factor (OVSF) codes allocated for the enhanced packet service; and
if the number of the E-DPDCHs is larger, demodulating the E-DPDCHs using OVSF codes allocated in an order of (Q, 4, 3), (I, 4, 2) and (Q, 4, 2) and additionally demodulating E-DPDCHs in the opposite order of the OVSF codes allocated in an order of (I, 4, 1), (Q, 4, 1) and (I, 4, 3) for the DPDCHs, thereby to receive enhanced packet data.

11. A method for supporting an enhanced packet service by a user equipment (UE) in a mobile communication system, the method comprising the steps of:
determining the maximum number of enhanced uplink dedicated physical data channels (E-DPDCHs) that can be simultaneously transmitted;
comparing the number of Orthogonal Variable Spreading Factor (OVSF) codes needed for the enhanced packet service with the determined number of the E-DPDCHs; and
if the number of the E-DPDCHs is larger, sequentially reallocating OVSF codes allocated for dedicated physical channels (DPDCHs) over which the enhanced packet data is not transmitted at a transmission time, to E-DPDCHs.

12. The method of claim 11, wherein the step of reallocating OVSF codes comprises the step of sequentially reallocating remaining OVSF codes except OVSF codes used for the DPDCHs among OVSF codes of (I, 4, 1), (Q, 4, 1), (I, 4, 3), (Q, 4, 3), (I, 4, 2) and (Q, 4, 2) determined for the DPDCHs, to the E-DPDCHs.

13. The method of claim 11, wherein the UE sequentially reallocates OVSF codes of (I, 4, 1), (I, 4, 3), (Q, 4, 3), (I, 4, 2) and (Q, 4, 2) except an OVSF code (Q, 4, 1) determined for high-speed packet service, to the E-DPDCHs.

14. A method for supporting an enhanced packet service by a Node B in a mobile communication system, the method comprising the steps of:
receiving a control channel including transport format information indicating the maximum number of transmittable enhanced data channel (E-DPDCHs), and the E-DPDCHs;
determining whether the number of the E-DPDCHs is larger than the number of Orthogonal Variable Spreading Factor (OVSF) codes allocated for the enhanced packet service; and
if the number of the E-DPDCHs is larger, demodulating the E-DPDCHs sequentially using remaining OVSF codes except OVSF codes used for the DPDCHs among OVSF codes of (I, 4, 1), (Q, 4, 1), (I, 4, 3), (Q, 4, 3), (I, 4, 2) and (Q, 4, 2) determined for the DPDCHs, thereby to receive the enhanced packet data.
